(19) United States
(12) Patent Application Publication
(10) Pub. No.: US 2003/0184616 A1
(43) Pub. Date: Oct. 2, 2003

(54) NOZZLE PLATE AND MANUFACTURING METHOD THEREOF

(76) Inventors: MING-HSUN YANG, TAIPEI (TW); GUEY-CHYUAN CHEN, TAOYUAN (TW); CHIH-CHIEH HSU, HSINCHU (TW); YI-REN HWANG, TAINAN (TW); KUNG LINLIU, HSINCHU (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/249,242

(22) Filed: Mar. 26, 2003

(30) Foreign Application Priority Data
Mar. 29, 2002 (TW) 91106260

(51) Int. Cl. B41J 2/14

(52) U.S. Cl. 347/47; 347/45

(57) ABSTRACT

A nozzle plate and a method of fabricating a nozzle plate on an inkjet print head are provided. A patterned first nozzle layer is formed over an ink wall layer over the inkjet print head. The first nozzle layer has at least a first opening. The wall of the first opening is treated to form a hydrophilic surface. Thereafter, a patterned second nozzle layer is formed over the first nozzle layer. The second nozzle layer has at least a second opening having connection with the first opening. The wall of the second opening is treated to form a hydrophobic surface. The first nozzle layer and the second nozzle layer together form a nozzle plate. The first opening and the second opening together form a nozzle with the lower section of the wall hydrophilic but the upper section of the wall hydrophobic.

### CROSS REFERENCE TO RELATED APPLICATIONS

This application claims the priority benefit of Taiwan application serial no. 91106260, filed on Mar. 29, 2002.

### BACKGROUND OF INVENTION

1. Field of Invention

The present invention relates to a nozzle plate and manufacturing method thereof. More particularly, the present invention relates to a nozzle plate and manufacturing method thereof for an inkjet print head.

2. Description of Related Art

According to operating mechanism, ink jet printers can be divided into two major types, namely, a thermal bubble inkjet printer or a piezoelectric inkjet printer. Thermal bubble printing relies on a heater to heat up a small quantity of ink rapidly so that the ink is immediately transformed into vapor. The vapor creates a high-pressure bubble forcing the ink out from a nozzle to form droplet on a print document. In the piezoelectric printing, the print head is fabricated using a piezoelectric ceramic material. When a voltage is applied to the piezoelectric material, the material deforms so that high pressure is created inside an ink port to force a small jet of ink out from a nozzle. In brief, both the thermal bubble and the piezoelectric inkjet technique utilize the transient creation of a high-pressure to squeeze ink from an ink port through a nozzle plate.

A conventional nozzle plate is fabricated from metal including, for example, nickel. In general, the surface of a metallic nozzle plate has good hydrophilic properties. A material surface is considered hydrophilic if the contact angle water on the surface is smaller than 90°. However, for a hydrophilic surface, the following three conditions may occur when a portion of the ink is forced to eject from a nozzle plate as ink droplets:

1. The tail end of an ink droplet that leaves the nozzle may deviate from the desired forward direction due to traction by the edges at the very end of the nozzle wall.

2. Due to traction of the edges at the very end of the nozzle wall, many smaller ink droplets may follow the tail end of an ink droplet leaving the nozzle so that a satellite of dots surrounding a principal ink dot often occur on a piece of print document.

3. Similarly, due to traction of the edges at the very end of the nozzle wall, the ink droplet leaving the nozzle generates a meniscus profile. Hence, ink droplets with air inside are often formed. These hollow ink droplets will form circular ink drops instead of a solid drop on a piece of print document.

Conventionally, to prevent ink drops from shooting at an angle or forming satellite or ring dots on a document, a hydrophobic treatment of the surface of the nozzle plate is carried out so that the post-treated contact angle must be smaller than a specified value (generally between 90°-110°). Furthermore, sidewall of the nozzle must also be treated so that the contact angle is also at a desired level. However, complicated processing steps including mask-making or sacrificial material deposition as disclosed in U.S. Pat. Nos. 5,502,470, 5,759,421, 6,016,601 and 6,126,269 are often required to turn the sidewalls of a nozzle into a hydrophobic surface. In other words, the improvement comes at the expense of considerable processing time and production cost.

### SUMMARY OF INVENTION

Accordingly, one object of the present invention is to provide a nozzle plate and manufacturing process thereof. A thick film is used to serve as a nozzle plate and simple processes are deployed to convert a particular surface into one having hydrophilic or hydrophobic properties so that overall cost of producing a nozzle plate is reduced.

To achieve these and other advantages and in accordance with the purpose of the invention, as embodied and broadly described herein, the invention provides a manufacturing method for fabricating a nozzle plate on an inkjet print head. First, a patterned first nozzle layer is formed over an ink-wall layer. The first nozzle layer has a first opening whose interior sidewalls are hydrophilic. The sidewall surface of the first opening is either intrinsically hydrophilic because the first nozzle layer is fabricated using a hydrophilic material or hydrophilic after performing a hydrophilic treatment of the surface. Thereafter, a patterned second nozzle layer is formed over the first nozzle layer. The second nozzle layer has a second opening whose interior sidewalls are hydrophobic. The sidewall surface of the second opening is either intrinsically hydrophobic because the second nozzle layer is fabricated using a hydrophobic material or hydrophobic after performing a hydrophobic treatment of the surface. The first nozzle layer and the second nozzle layer together constitute a nozzle plate and that the first opening on the first nozzle layer and the second opening on the second nozzle layer together form a nozzle in the nozzle plate.

In addition, the aforementioned method of forming a hydrophilic/hydrophobic double layer can also be used to fabricate the ink-wall layer and the nozzle plate of the inkjet print head. Afterwards, a reverse development process can be carried out to form a nozzle with optimal sectional profile on the nozzle plate.

It is to be understood that both the foregoing general description and the following detailed description are exemplary, and are intended to provide further explanation of the invention as claimed.

### BRIEF DESCRIPTION OF DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIGS. 1A and 1B are schematic cross-sectional views showing the steps for fabricating a nozzle plate over a piezoelectric inkjet print head according to a first embodiment of this invention;

FIGS. 2A and 2B are schematic cross-sectional views showing the steps for fabricating a nozzle plate over a thermal bubble print head according to a second embodiment of this invention; and

FIGS. 3A to 3D are schematic cross-sectional views showing the steps for fabricating a thermal bubble print head according to a third embodiment of this invention.

### DETAILED DESCRIPTION

Reference will now be made in detail to the present preferred embodiments of the invention, examples of which are illustrated in the accompanying drawings. Wherever possible, the same reference numbers are used in the drawings and the description to refer to the same or like parts.

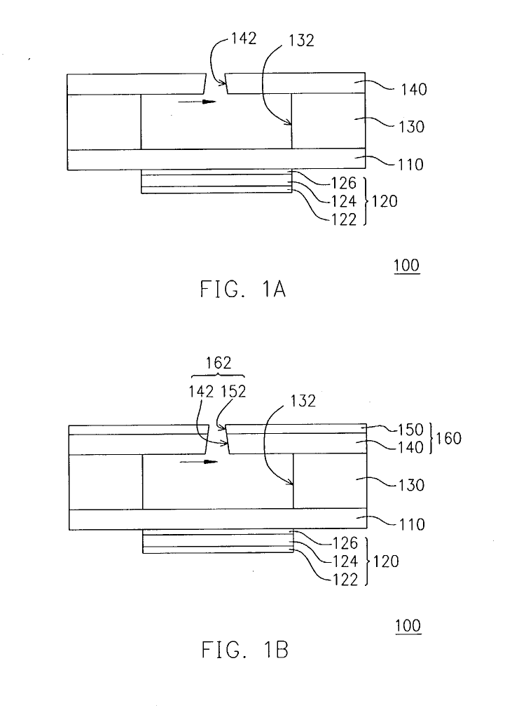

FIGS. 1A and 1B are schematic cross-sectional views showing the steps for fabricating a nozzle plate over a piezoelectric inkjet print head according to a first embodiment of this invention. As shown in FIG. 1A, a piezoelectric (PZT) element 120 is fixed onto the bottom surface of a substrate 110. The PZT element 120 comprises an upper electrode layer 122, a piezoelectric layer 124 and a lower electrode layer 126. When a voltage is applied to piezoelectric layer 124 through the upper electrode layer 122 and the lower electrode layer 126, the piezoelectric layer deforms transiently and squeezes ink inside an inkpot 132. The substrate 110 serves as a vibrating media. The upper surface of the substrate 110 has a patterned ink wall layer 130 enclosing the inkpot 132. Note that the piezoelectric element 120 and the ink wall layer 130 may be located on the same upper surface of the substrate 110 so that the piezoelectric element 120 is enclosed inside the inkpot 132.

To form a nozzle plate 162 over the piezoelectric ink jet print heat 100 in FIG. 1A, a patterned first nozzle layer 140 is formed over the ink wall layer 130. The first nozzle layer 140 has a first opening 142 connected to the inkpot 132. The first nozzle layer 140 is fabricated using a photosensitive material including, for example, dry film, epoxy, novolak, acrylate, polyimide or polyamide. The first nozzle layer is formed, for example, by attaching a photosensitive material layer over the ink wall layer 130, conducting a photolithographic process and finally performing a chemical development of the material to form the first opening 142. Note that a reverse developing process can be carried out. In the reverse developing process, chemical developer is injected into the interior of the inkpot 132 so that the chemical developer flows in a direction (indicated by an arrow) from the bottom surface of the first nozzle layer 140 to the upper surface of the first nozzle layer 140. After the reverse developing process, a funnel or trapezoidal sectional profile is imprinted across the first opening 142.

After forming the first nozzle layer 140 over the ink wall layer 130, a second patterned nozzle layer 150 having at least a second opening 152 is formed over the first nozzle layer 140. The second opening 152 and the first opening 142 are connected. The second nozzle layer 150 can be fabricated using a photosensitive material including, for example, dry film or spin-coated glass. The second patterned nozzle layer 150 is formed, for example, by depositing photosensitive material over the first nozzle layer 140 to form a photosensitive layer, exposing the photosensitive layer to light and finally developing the exposed photosensitive material chemically. To form a second nozzle layer 150 using spin-coated glass, a spin-coating or a spraying process is carried out to form a glass layer over the first nozzle layer 140 without the first opening 142. Next, the glass layer is cured to produce the second nozzle layer 150. Finally, the first opening 142 and the second opening 152 are formed through the nozzle layer 140 and the nozzle layer 150 respectively. Similarly, chemical developer can be injected into the interior of the inkpot 132 in a reverse developing process. The chemical developer flows in a direction (indicated by an arrow) from the bottom surface of the first nozzle layer 140 to the upper surface of the second nozzle layer 150. After the reverse developing process, a funnel or trapezoidal sectional profile is also imprinted across the second opening 152. The second nozzle layer 150 and the first nozzle layer 140 together form a nozzle plate structure 160. Meanwhile, the first opening 142 and the second opening 152 together form a nozzle structure 162 having a funnel or trapezoidal sectional profile.

Since the interior surface of the first opening 142 must be hydrophilic, the first nozzle layer 140 is fabricated using hydrophilic material including, for example, a material containing soap radicals. However, a chemical bonding method can also be applied to attach hydrophilic radicals such as soap radicals onto the surface of the first nozzle layer 140. Alternatively, a dip coating method can be applied to form an hydrophilic film (not shown) such as an activated interfacial layer with soap radicals therein over the surface of the first nozzle layer 140.

Since the interior surface of the second opening 152 must be hydrophobic, the second nozzle layer 150 is fabricated using hydrophobic material including, for example, a material containing Teflon radicals. Alternatively, the second nozzle layer 150 can be fabricated using a dry film material or a spin-coated glass. However, a chemical bonding method can be applied to attach hydrophobic radicals such as Teflon radicals or carbon tetrafluoride onto the surface of the second nozzle layer 150. Alternatively, a dip coating method can be applied to form a hydrophobic film (not shown) with Teflon therein over the surface of the second nozzle layer 150.

In addition, spin-coated glass can be sprayed over the first nozzle layer 140 to serve as a hydrophobic layer after forming the first nozzle layer 140 and the first opening 142. The spin-coated glass layer on top of the first nozzle layer 140 serves the same purpose as the second nozzle layer 150 in FIG. 1B. However, a portion of the spin-coated glass may land on the interior surface of the first opening 142. To rectify the situation, a defocus method can be applied such that the spin-coated glass on the upper section of the interior wall of the first opening 142 is exposed while the spin-coated glass on the lower section of the interior wall of the first opening 142 remains unexposed. Therefore, after chemically developing the unexposed spin-coated glass, the spin-coated glass layer on the lower section of the first opening 142 is removed while the spin-coated glass layer on the upper section of the first opening 142 is retained. This means that the upper section of the first opening 142 is hydrophobic while the lower section of the opening 142 is hydrophilic. In other words, the first nozzle layer 140 and the first opening 142 together with a spin-coated glass spraying and a defocusing process can be used to form a hydrophobic film on the upper section of the first opening 142 instead of forming a second nozzle layer 150.

The nozzle plate and manufacturing method thereof according to the first embodiment of this invention can be applied to fabricate an inkjet print head, in particular, for forming a nozzle plate over a piezoelectric inkjet print head. First, a patterned first nozzle layer is formed over an ink wall layer. The first nozzle layer has a first opening. The interior surface of the first opening is rendered hydrophilic by some means including, for example, fabricating the first nozzle layer with hydrophilic material or treating the interior surface of the first opening with hydrophilic substances. Next, a second nozzle layer with a second opening is formed over the first nozzle layer. The interior surface of the second opening is rendered hydrophobic by some means including, for example, fabricating the second nozzle layer with hydrophobic material or treating the interior surface of the second opening with hydrophobic substances. The first nozzle layer and the second nozzle layer together form a nozzle plate structure. Meanwhile, the first opening and the second opening together form a nozzle inside the nozzle plate.

The aforementioned nozzle plate is assembled from two nozzle layers such that either the nozzle layers are separately fabricated with hydrophilic and hydrophobic material or separated treated using hydrophilic and hydrophobic substances subsequently. Hence, a nozzle plate with a nozzle whose interior surface is partitioned into a hydrophilic and hydrophobic section can be fabricated by performing rather simple manufacturing steps.

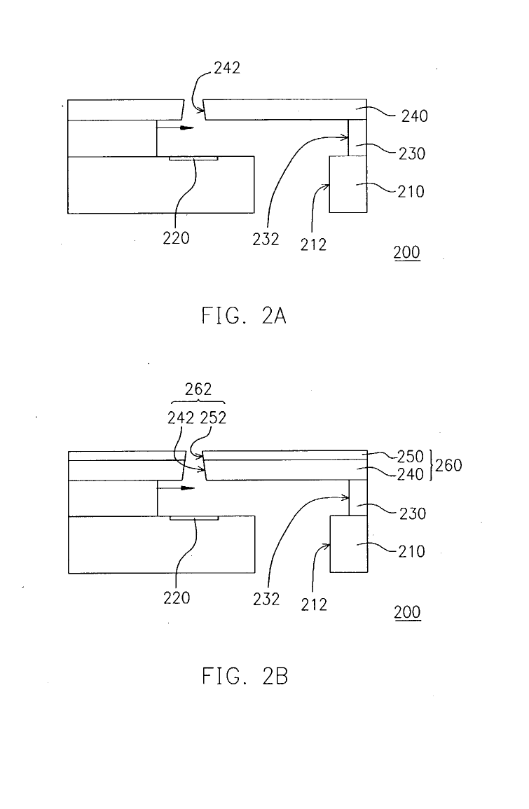

FIGS. 2A and 2B are schematic cross-sectional views showing the steps for fabricating a nozzle plate over a thermal bubble print head according to a second embodiment of this invention. The second embodiment differs from the first embodiment in that the nozzle plate is formed on a thermal bubble print head.

As shown in FIG. 2A, a chip 210 with an ink channel 212 passing through the chip is provided. A heating element 220 is set up on the chip 210. An ink wall layer 230 is also set up over the chip 210. An inkpot connected to the ink channel 212 is located right above the heating element 220. To form the nozzle plate over the thermal bubble print head, a patterned first nozzle layer 240 is formed over the ink wall layer 230. The patterned first nozzle layer 240 has a first opening 242 that connects with the inkpot 232. Note that a reverse developing process can be carried out. In the reverse developing process, chemical developer is injected into the interior of the inkpot 232 via the ink channel 212 so that the chemical developer flows in a direction (indicated by an arrow) from the bottom surface of the first nozzle layer 240 to the upper surface of the first nozzle layer 240. After the reverse developing process, a funnel or trapezoidal sectional profile is imprinted across the first opening 242. Since the method of turning the interior of the first opening 242 into a hydrophilic surface has already been disclosed in the first embodiment, detail description is not repeated here.

As shown in FIG. 2B, a patterned second nozzle layer 250 is formed over the first nozzle layer 240. The second nozzle layer 250 has a second opening 252 that connects with the first opening 242. Similarly, chemical developer can be injected into the interior of the inkpot 232 in a reverse developing process. The chemical developer flows in a direction (indicated by an arrow) from the first opening 242 to the upper surface of the second nozzle layer 250. After the reverse developing process, a funnel or trapezoidal sectional profile is also imprinted across the second opening 252. Since the method of turning the interior of the second opening 252 into a hydrophobic surface has already been disclosed in the first embodiment, detailed description is not repeated here. The second nozzle layer 250 and the first nozzle layer 240 together form a nozzle plate structure 260. Meanwhile, the first opening 242 in the first nozzle layer 240 and the second opening 252 in the second nozzle layer 250 together form a nozzle structure 262 with a funnel or trapezoidal sectional profile.

The nozzle plate and manufacturing method thereof according to the second embodiment of this invention can be applied to fabricate an inkjet print head, in particular, for forming a nozzle plate over a thermal bubble print head. Similarly, the nozzle plate is assembled from two nozzle layers such that either the nozzle layers are separately fabricated with hydrophilic and hydrophobic material or separately treated using hydrophilic and hydrophobic substances subsequently. Hence, a nozzle plate with a nozzle whose interior surface is partitioned into a hydrophilic and hydrophobic section can be fabricated by performing rather simple manufacturing steps.

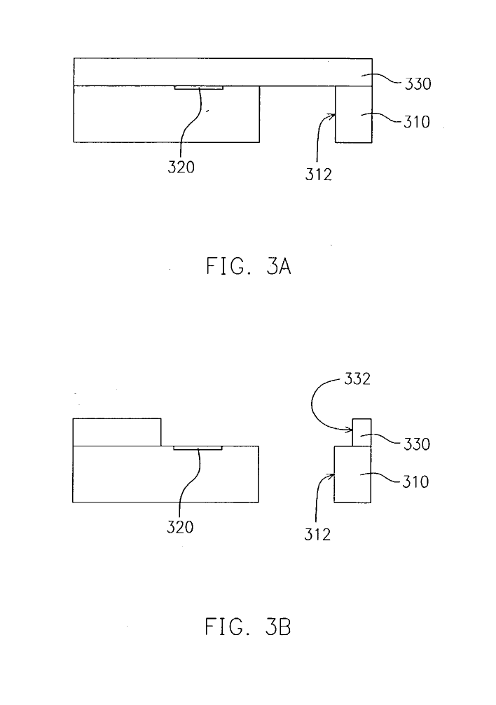

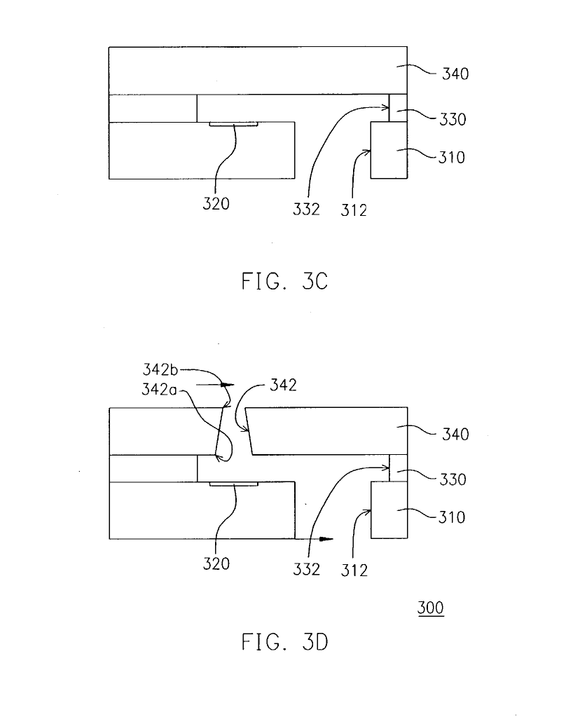

FIGS. 3a to 3D are schematic cross-sectional views showing the steps for fabricating a thermal bubble print head according to a third embodiment of this invention. The third embodiment differs from the second embodiment in that an hydrophilic ink wall layer and hydrophobic nozzle plate are employed to form portions of the thermal bubble print head. Moreover, the nozzle plate is fabricated using photosensitive thick film and reverse developing process is used to optimize the sectional profile of the nozzle.

As shown in FIG. 3A, a chip 310 having an ink channel 312 is provided. The ink channel 312 passes through the chip 310. A heating element 320 is set up on the upper surface of the chip 310. An ink wall layer 330 is formed over the chip 310. The ink wall layer 330 is fabricated using a photosensitive material.

As shown in FIG. 3B, the ink wall layer 330 is patterned to form an inkpot cavity 332 in the middle by conducting a photo-exposure of the ink wall layer 330 and chemically developing the exposed ink wall layer 330 thereafter.

As shown in FIG. 3C, a photosensitive thick film 340 is formed over the patterned ink wall layer 330. The photosensitive thick film 340 around the desired nozzle 342 location is exposed. Thereafter, as shown in FIG. 3D, chemical developer is injected into the inkpot cavity 332 via the ink channel 312 following the labeled direction (indicated by arrows) to develop the exposed photosensitive film 340 and form a nozzle 342. The nozzle 342 has two ends including an ink inlet terminal 342a and an ink outlet terminal 342b. The ink inlet terminal 342a has a diameter larger than the ink outlet terminal 342b. In other words, the nozzle 342 has an inverted frustum profile that can stabilize ink flow in the forward direction.

To ensure a continuous supply of ink into the ink cavity 332, the sidewalls of the ink cavity 332 must be hydrophilic. The walls enclosing the ink cavity 332 can be turned into a hydrophilic surface by carrying out the steps in the treatment of the interior surface of the first nozzle layer 140 in the first embodiment. Similarly, to prevent the traction of ink droplets by the side edges after leaving the nozzle 342, that is, to prevent traction by the edges at the ink outlet 342b, the photosensitive thick film 340 must be hydrophobic, in particular, the interior surface of the nozzle 342. Here, the method of rendering the second nozzle layer 150 hydrophobic in the first embodiment of this invention can be used to turn the interior surface of the nozzle 342 hydrophobic.

In the third embodiment of this invention, reverse developing process is employed to form a nozzle with an optimal sectional profile so that the ink jet emitted from the nozzle is more stable. In addition, the thermal bubble print head has an ink cavity enclosed by hydrophilic walls and a nozzle plate having hydrophobic properties. Thus, ink is easily attracted into the ink cavity but less readily attracted by the edges of nozzle once the ink leaves the nozzle.

In conclusion, the nozzle plate according to this invention is assembled from two nozzle layers such that either the nozzle layers are separately fabricated with hydrophilic and hydrophobic material or separately treated using hydrophilic and hydrophobic substances subsequently. Hence, the interior surface of the nozzle is partitioned into a hydrophilic lower section and a hydrophobic upper section. Furthermore, the hydrophilic/hydrophobic double-layered structure can also be applied to fabricate the ink wall layer and the nozzle plate of a thermal bubble print head so that ink is easily channeled into the ink cavity and yet an ink jet leaving the nozzle is still able to aim straight.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

1. A nozzle plate for an inkjet print head, at least comprising:
a first nozzle layer on the inkjet print head, wherein the first nozzle layer has at least a first opening; and
a second nozzle layer over the first nozzle layer, wherein the second nozzle layer has at least a second opening connected to the first opening.

2. The nozzle plate of claim 1, wherein the first nozzle layer is fabricated using hydrophilic material so that the wall of the first opening is hydrophilic.

3. The nozzle plate of claim 2, wherein the first nozzle layer is fabricated using a material containing soap radicals.

4. The nozzle plate of claim 1, wherein the second nozzle layer is fabricated using a hydrophobic material so that the wall of the second opening is hydrophobic.

5. The nozzle plate of claim 4, wherein the second nozzle layer is fabricated using a material including a dry film.

6. The nozzle plate of claim 4, wherein the second nozzle layer is fabricated using a material including spin-coated glass.

7. The nozzle plate of claim 4, wherein the second nozzle layer is fabricated using a material containing Teflon radicals.

8. The nozzle plate of claim 1, wherein the wall of the first opening has a hydrophilic film so that the interior surface of the first opening is hydrophilic.

9. The nozzle plate of claim 1, wherein the wall of the second opening has a hydrophobic film so that the interior surface of the second opening is hydrophobic.

10. The nozzle plate of claim 9, wherein material constituting the hydrophobic film includes Teflon.

11. A method of fabricating a nozzle plate over an inkjet print head, comprising the steps of:
forming a patterned first nozzle layer over the inkjet print head, wherein the first nozzle layer has a first opening; and
forming a patterned second nozzle layer over the first nozzle layer, wherein the second nozzle layer has a second opening connected to the first opening.

12. The method of claim 11, wherein the first nozzle layer is fabricated using a hydrophilic material so that the wall of the first opening is hydrophilic.

13. The method of claim 12, wherein the first nozzle layer is fabricated using a material containing soap radicals.

14. The method of claim 11, wherein the second nozzle layer is fabricated using a hydrophobic material so that the wall of the second opening is hydrophobic.

15. The method of claim 14, wherein the second nozzle layer is fabricated using a material including dry film.

16. The method of claim 14, wherein the second nozzle layer is fabricated using a material including spin-coated glass.

17. The method of claim 14, wherein the second nozzle layer is fabricated using a material containing Teflon radicals.

18. The method of claim 14, wherein after forming the patterned first nozzle layer but before forming the patterned second nozzle layer, further includes treating the wall of the first nozzle with hydrophilic material so that the wall of the first opening is hydrophilic.

19. The method of claim 11, wherein the step of treating the first nozzle layer with hydrophilic material includes bonding a plurality of hydrophilic radicals onto the surface of the first nozzle layer.

20. The method of claim 19, wherein the hydrophilic radicals include soap radicals.

21. The method of claim 11, wherein after forming the patterned first nozzle layer but before forming the second patterned nozzle layer, further includes forming a hydrophilic film over the wall of the first opening so that the wall of the first opening is hydrophilic.

22. The method of claim 21, wherein the hydrophilic thin film is formed over the wall of the first opening by dip coating.

23. The method of claim 11, wherein after forming the patterned second nozzle layer, further includes treating the wall of the second opening with hydrophobic material so that the wall of the second opening is hydrophobic.

24. The method of claim 23, wherein a process for the second opening being hydrophobic includes attaching a plurality of hydrophobic radicals to the wall of the second opening.

25. The method of claim 24, wherein the hydrophobic radicals include Teflon radicals.

26. The method of claim 24, wherein the hydrophobic radicals include carbon tetrafluoride.

27. The method of claim 11, wherein after forming the patterned second nozzle layer, further includes forming a hydrophobic film on the wall of the second opening so that the wall of the second opening is hydrophobic.

28. The method of claim 27, wherein material constituting the hydrophobic film includes Teflon.

29. The method of claim 27, wherein the hydrophobic film is formed by dip coating.

30. The method of claim 11, wherein the first nozzle layer is fabricated using a material including photosensitive thick film.

31. The method of claim 30, wherein the first nozzle layer is patterned by photo-exposing the layer and developing the photo-exposed material chemically.

32. The method of claim 11, wherein the second nozzle layer is fabricated using a material including photosensitive thick film.

33. The method of claim 32, wherein the second nozzle layer is patterned by photo-exposing the layer and developing the photo-exposed material chemically.

34. A method of fabricating a thermal bubble inkjet print head, at least comprising the steps of:
providing a chip having at least a heating element and an ink channel, wherein the heating element is on the surface of the chip while the ink channel passes right through the chip;
forming a patterned ink wall layer over the chip, wherein the ink wall layer encloses at least an ink cavity located above the heating element and connected with the ink channel;
forming a hydrophilic photosensitive thick film over the ink wall layer;
photo-exposing a portion of the photosensitive thick film; and
passing chemical developer into the ink cavity through the ink channel so that the photo-exposed material is developed to form at least a nozzle with an ink inlet and an ink outlet in the photosensitive thick film such that the ink inlet has a hole diameter greater than the ink outlet.

35. The thermal bubble print head of claim 34, wherein the ink wall layer is fabricated using a material including photosensitive thick film.

36. The thermal bubble print head of claim 35, wherein the ink wall layer is patterned by performing a photo-exposure of the ink wall material followed by developing the photo-exposed material chemically.

37. The thermal bubble print head of claim 34, wherein the ink wall layer is fabricated using a hydrophilic material.

38. The thermal bubble print head of claim 37, wherein the ink wall layer is fabricated using a material containing soap radicals.

39. The thermal bubble print head of claim 34, wherein the photosensitive thick film is fabricated using a material containing Teflon.

40. The thermal bubble print head of claim 34, wherein after patterning the ink wall layer but before forming the photosensitive thick film, further includes treating the exposed surface of the ink wall layer with hydrophilic material.

41. The thermal bubble print head of claim 40, wherein the step of treating the ink wall layer with hydrophilic material includes bonding a plurality of hydrophilic radicals to the exposed surface of the ink wall layer.

42. The thermal bubble print head of claim 41, wherein the hydrophilic radicals includes soap radicals.

43. The thermal bubble print head of claim 40, wherein the step of treating the ink wall layer with hydrophilic material includes forming a hydrophilic film over the exposed surface of the ink wall layer.

44. The thermal bubble print head of claim 43, wherein the hydrophilic film is formed by dip coating.

45. A method of fabricating a thermal bubble inkjet print head, at least comprising the steps of:
providing a chip having at least a heating element and an ink channel, wherein the heating element is on the chip and the ink channel passes through the chip;
forming an ink wall layer over the chip;
patterning the ink wall layer to enclose at least an ink cavity, wherein the ink cavity is above the heating element and connected with the ink channel;
forming a photosensitive thick film over the ink wall layer;
photo-exposing a portion of the photosensitive thick film;
passing chemical developer into the ink cavity through the ink channel so that the photo-exposed material is developed to form at least a nozzle with an ink inlet and an ink outlet in the photosensitive thick film such that the ink inlet has a hole diameter greater than the ink outlet.

46. The thermal bubble print head of claim 45, wherein the ink wall layer is fabricated using a material including photosensitive thick film.

47. The thermal bubble print head of claim 46, wherein the ink wall layer is patterned by performing a photo-exposure of the ink wall material followed by developing the photo-exposed material chemically.

48. The thermal bubble print head of claim 45, wherein the ink wall layer is fabricated using a hydrophilic material.

49. The thermal bubble print head of claim 48, wherein the ink wall layer is fabricated using a material containing soap radicals.

50. The thermal bubble print head of claim 45, wherein after patterning the ink wall layer but before forming the photosensitive thick film, further includes treating the exposed surface of the ink wall layer with hydrophilic material.

51. The thermal bubble print head of claim 50, wherein the step of treating the ink wall layer with hydrophilic material includes bonding a plurality of hydrophilic radicals to the exposed surface of the ink wall layer.

52. The thermal bubble print head of claim 51, wherein the hydrophilic radicals includes soap radicals.

53. The thermal bubble print head of claim 50, wherein the step of treating the ink wall layer with hydrophilic material includes forming a hydrophilic film over the exposed surface of the ink wall layer.

54. The thermal bubble print head of claim 53, wherein the hydrophilic film is formed by dip coating.

55. The thermal bubble print head of claim 45, wherein after developing the photo-exposed photosensitive thick film, further includes treating the exposed surface of the photosensitive thick film with hydrophobic material.

56. The thermal bubble print head of claim 55, wherein the step of treating the photosensitive thick film with hydrophobic material includes bonding a plurality of hydrophobic radicals onto the exposed surface of the photosensitive thick film.

57. The thermal bubble print head of claim 56, wherein the hydrophobic radicals include Teflon radicals.

58. The thermal bubble print head of claim 56, wherein the hydrophobic radicals include carbon tetrafluoride.

59. The thermal bubble print head of claim 55, wherein the step of treating the photosensitive thick film with hydrophobic material includes forming a hydrophobic film over the exposed surface of the photosensitive thick film.

60. The thermal bubble print head of claim 59, wherein material constituting the hydrophobic film includes Teflon.

61. The thermal bubble print head of claim 59, wherein the hydrophobic thin film is fabricated by dip coating.

62. A method of fabricating a nozzle plate on an inkjet print head, at least comprising the steps of:
forming a patterned first nozzle layer over the inkjet print head, wherein the first nozzle layer has a first opening; and
spraying hydrophobic material to form a hydrophobic film over the surface of the first nozzle layer and the upper wall section of the first opening.

63. The method of claim 62, wherein after spraying hydrophobic material, further includes removing the hydrophobic film attached to the lower wall section of the first opening.

64. The method of claim 62, wherein material constituting the hydrophobic film includes spin-coated glass.

65. The method of claim 62, wherein the step of removing the hydrophobic film attached to the lower section of the first opening includes conducting a defocusing exposure followed by developing the photo-exposed material chemically.
